(19) United States
(12) Patent Application Publication
(10) Pub. No.: US 2024/0160042 A1
(43) Pub. Date: May 16, 2024

(54) OXYGEN PERMEABLE ELECTRONIC CONTACT LENSES FABRICATED USING A SOLIDIFICATION PROCESS

(71) Applicant: Tectus Corporation, Saratoga, CA (US)

(72) Inventor: Benjamin Lyle Hackett, Saratoga, CA (US)

(21) Appl. No.: 17/985,149

(22) Filed: Nov. 11, 2022

(51) Int. Cl. G02C 7/04; G02C 11/00

(52) U.S. Cl. CPC G02C 7/04; G02C 11/10; G06F 3/013

(57) ABSTRACT

The posterior surface of the contact lens (i.e., the surface that faces inwards towards the eye) includes an oxygen-permeable base. The anterior surface of the contact lens includes a cap that also provides oxygen transport. An intermediate structure is formed by a solidification process, such as casting. Once solidified, this element forms an air chamber between the base and the cap. It may also secure the base and the cap. When the electronic contact lens is worn by the user, the cap, air chamber and base provide an oxygen path from the external environment to the user's cornea. The electronic contact lens also contains an electronics payload, some of which may be encapsulated by the solidified structure during the solidification process.

### BACKGROUND

### 1. Technical Field

This disclosure relates generally to contact lenses and in particular to oxygen permeable thick contact lenses, for example scleral contact lenses that carry electronics payloads.

### 2. Description of Related Art

Contact lenses that provide refractive vision correction are commonplace. Most contact lenses in use today are so-called soft contact lenses. They are relatively thin and made of oxygen permeable hydrogels. Oxygen passes through the contact lens material to the cornea. Sufficient oxygen supply is an important requirement for any contact lens because, due to the lack of blood vessels within the human cornea, the tissue that makes up the cornea receives oxygen through exposure to the air. Without a sufficient flow of oxygen through the contact lens, the cornea would suffer.

Recently, there has been increased interest in contact lenses that perform functions other than vision correction. In many of these applications, a contact lens may carry a payload for performing various functions. For example, an electronic contact lens may contain a payload of one or more electrical components, such as projectors, imaging devices (cameras), sensors, batteries, MEMS (micro-electro-mechanical systems), gyroscopes, etc. The contact lens must have a sufficient thickness and structural integrity to accommodate the payload. However, increasing the thickness of a contact lens reduces the amount of oxygen that is transmitted through the material of the contact lens to reach the cornea. Often, the payload itself also is not gas permeable, which further reduces the oxygen flow.

As a result, it can be challenging to provide an oxygenation path from the external environment to the cornea, while still meeting the other requirements of the contact lens.

### BRIEF DESCRIPTION OF THE DRAWINGS

FIG. 1A shows a user wearing a display mounted in a scleral contact lens, in accordance with some embodiments.

FIG. 1B shows a cross sectional view of the scleral contact lens display of FIG. 1A.

FIG. 1C is a functional block diagram of an eye-mounted display using a scleral contact lens.

FIG. 2A is a perspective view of an electronic contact lens, in accordance with some embodiments.

FIG. 2B is a plan view of the electronic contact lens of FIG. 2A.

FIG. 2C is a cross-section through a perspective view of the electronic contact lens of FIG. 2.

FIGS. 3A-3D are cross-sections illustrating manufacture of the electronic contact lens of FIG. 2.

### DETAILED DESCRIPTION OF THE PREFERRED EMBODIMENTS

In order to ensure sufficient corneal oxygenation while maintaining sufficient structural integrity, an electronic contact lens may have the following construction. The posterior surface of the contact lens (i.e., the surface that faces inwards towards the eye) includes an oxygen-permeable base. The anterior surface of the contact lens includes a cap that also provides oxygen transport from the outside environment. An intermediate structure is formed by a solidification process, such as casting. Once solidified, this element forms an air chamber between the base and the cap. It may also secure the base and the cap. When the electronic contact lens is worn by the user, the cap, air chamber and base provide an oxygen path from the external environment to the user's cornea. The electronic contact lens also contains an electronics payload, some of which may be encapsulated by the solidified structure during the solidification process.

The electronic contact lens may be manufactured as follows. A precursor to the base, the electronics payload and a precursor to the cap are formed into an assembly. In the assembly, there are spaces between the base precursor and the cap precursor. Material is inserted into these spaces to form the intermediate element and then solidified in place. The solidified material forms an air chamber between the base precursor and the cap precursor and may also secure the base precursor and the cap precursor. The precursors are then shaped into the actual base and cap. This may be done by diamond turning, for example.

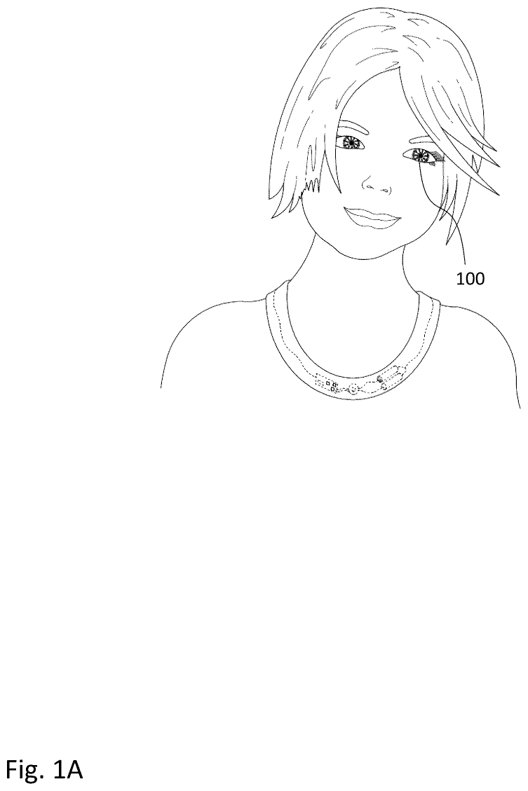

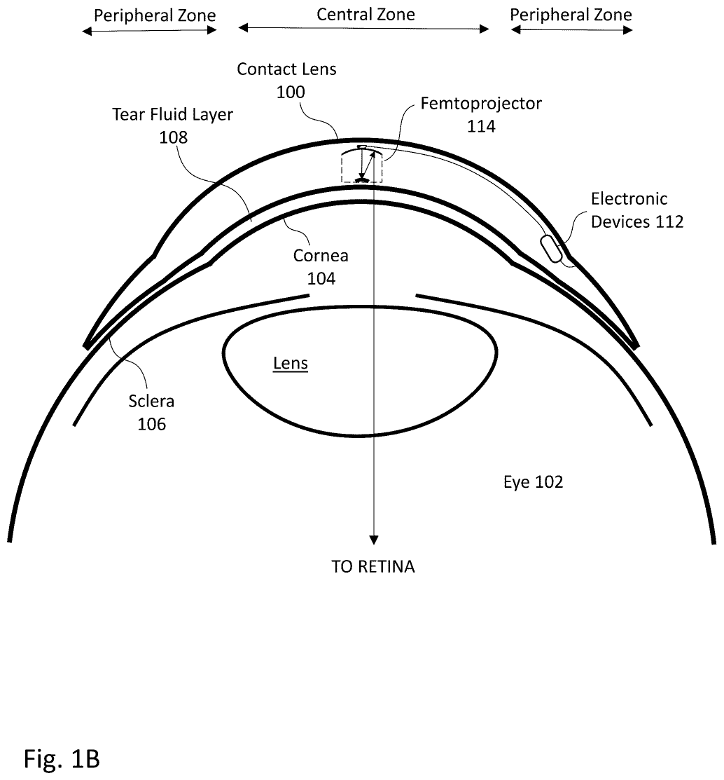

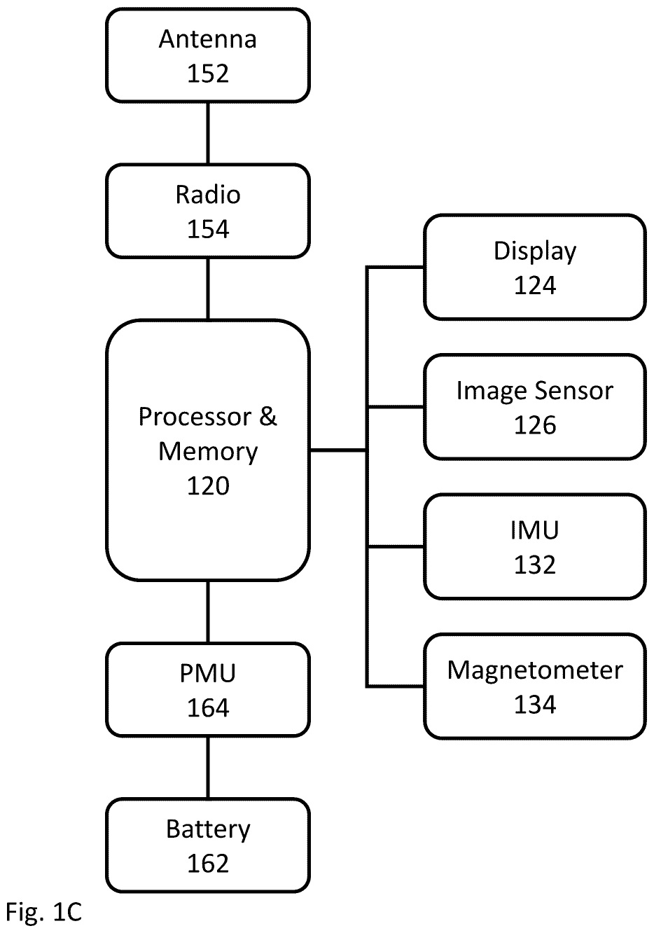

FIG. 1A shows a user wearing a display mounted in a scleral contact lens, in accordance with some embodiments. In some embodiments, the user may wear a scleral contact lens on one eye. In other embodiments, the user may wear a scleral contact lens on each eye. In cases where the user wears a pair of scleral contact lens, each of the scleral contact lenses may contain different payloads, allowing each scleral contact lens to perform different functions. For example, in some embodiments, each scleral contact lens may comprise a projector configured to project images into a respective eye of the user, but also comprise different sensors or other components to provide different types of functionality.

In some embodiments, due to space for processing components on the scleral contact lens being limited, the scleral contact lens 100 is configured to interface with an external device to provide certain functionalities, such as image processing functions, sensor analysis functions, etc. In addition, in some embodiments, the scleral contact lens 100 comprises a power coil configured to receive power wirelessly from an external device. In some embodiments, the external device is an accessary device worn by the user, such as a necklace, headband, glasses, or other wearable device. In other embodiments, the external device is an electronic device such as a mobile phone. In some embodiments, the scleral contact lens 100 may be powered by one or more batteries within the contact lens, and may interface with an external device for performing certain processing functions. In some embodiments, the external device may be configured to communicate with a remote server (e.g., a cloud server).

FIG. 1B shows a cross sectional view of the scleral contact lens mounted on the user's eye, in accordance with some embodiments. Scleral contact lenses are designed to be mounted on the sclera of the user's eye such that they do not move around on the wearer's eye when worn. The eye 102 includes a cornea 104 and a sclera 106. The scleral contact lens 100 is supported by the sclera 106 and vaults over the cornea 104, typically forming a tear fluid layer 108 between the contact lens 100 and the cornea. Oxygen permeates through the contact lens 100 and tear fluid layer 108 to the cornea 104, at a rate depending upon the geometry of the contact lens 100 and the oxygen transmissibility and thicknesses of the materials that form the contact lens 100 (not shown in this figure).

The contact lens 100 contains payload(s). These payloads may not be gas-permeable and also may require the contact lens to have a thickness and structural strength sufficient to accommodate and support the payloads. As a result, the approach used in soft contact lenses for corneal oxygenation typically will not be adequate for contact lens 100. In some embodiments, the payload(s) may include electronics, including electronics that require a power source such as a battery or a coil that is inductively powered. In the example of FIG. 1B, the payloads include a small projector that projects images onto the wearer's retina (referred to as a femtoprojector 114), and the corresponding electronics 112 to operate the femtoprojector. In some embodiments, the femtoprojector 114 and electronics 112 may be powered by a battery located within the contact lens 100 (not shown).

The femtoprojector 114 may include an LED frontplane with an LED array, an ASIC backplane with electronics that receives the data to drive the LED frontplane, and optics to project light from the LED array onto the retina. The femtoprojector 114 preferably fits into a 2 mm by 2 mm by 2 mm volume or even into a 1 mm by 1 mm by 1 mm volume. The contact lens 100 is sufficiently thick and structurally sound to support the femtoprojector 114 and electronics 112, while still maintaining adequate oxygen flow to the cornea.

To allow the femtoprojector 114 to project images onto the user's retina, the femtoprojector 114 may be positioned over the cornea. On the other hand, the electronics 112 may be positioned away from the cornea, as shown in FIG. 1B. For convenience, the contact lens 100 is divided into a central zone and a peripheral zone. The central zone refers to an area of the contact lens that overlaps the cornea 104 of the eye 102, while the area of the contact lens outside the cornea is referred to as the peripheral zone. As illustrated in FIG. 1B, the femtoprojector 114 is located within the central zone of the contact lens, while the electronics 112 and coil 145 are located in the peripheral zone. People have eyes of different sizes and shapes. The diameter of the boundary between the cornea and the sclera is typically between 10 and 12.5 mm, so for convenience, the central zone may be defined as the 10 mm diameter center area of the contact lens (i.e., within 5 mm radius of the center axis of the contact lens). Payload components that project light onto the retina typically will be located within the central zone due to the required optical path. Conversely, payload components that do not project light onto the retina or otherwise interact with the retina may be located on the edge of the central zone or outside the central zone so that they do not block light from reaching the retina.

Other examples of powered payloads include sensors, imagers, and eye tracking components such as accelerometers, gyroscopes and magnetometers. Payloads may also include passive devices, such as a coil or antenna for wireless power or data transmission, capacitors for energy storage, and passive optical structures (e.g., absorbing light baffles, beam-splitters, imaging optics). The contact lens 100 may also contain multiple femtoprojectors, each of which projects images onto the user's retina. Because the contact lens 100 moves with the user's eye 102 as the user's eye rotates in its socket, the femtoprojectors mounted in the contact lens 100 will also move with the user's eye and project to the same region of the retina. Some femtoprojector(s) may always project images to the fovea, and other femtoprojector(s) may always project images to more peripheral regions which have lower resolutions. As a result, different femtoprojectors may have different resolutions. The images from different femtoprojectors may be overlapping, to form a composite image on the wearer's retina. Contact lens having one or more femtoprojectors may hereafter referred to as “contact lens displays” or “eye mounted displays.”

FIG. 1C is a functional block diagram of an eye-mounted display using a scleral contact lens, in accordance with some embodiments. The payload of the contact lens includes a processor and memory 120, which are connected to and interact with various other components. Imaging components in the contact lens payload include a display 124 (femtoprojector) that projects images onto the user's retina, and an image sensor 126 (femtoimager) that captures images. The femtoimager 126 may be outwards facing, in which case it captures images of the surrounding environment. Alternatively, it may be inwards facing, in which case it captures images of the user's retina.

Other components in the payload include the following. An inertial measurement unit (IMU) 132 and magnetometer 134 measure quantities that can be used for eye tracking. Antenna 152 and radio 154 provide a wireless communications link from the contact lens to other components. The battery 162 and power management unit (PMU 164) provide power to the components in the contact lens. The battery 162 may be wirelessly charged.

In some embodiments, the data receive path for the display 124 includes antenna 152, radio 154, processor 120 which implements data processing, and display 124. Data from an external source (e.g., an external device such as an accessory device) is wirelessly transmitted to the display via the antenna 152. The radio 154 performs the functions for receiving the data, for example demodulation, noise filtering, and amplification. It also converts the received signals to digital form. The processor 120 processes the digital signals for the femtoprojector 124. These functions may include decoding and timing. The processing may also depend on other signals generated internally within the contact lens, for example eye tracking signals from the IMU 132 and magnetometer 134, or ambient light sensing. The femtoprojector 124 then projects the corresponding images onto the user's retina. In some embodiments, the femtoprojector 124 may include a CMOS ASIC backplane, LED frontplane and optics.

The subsystem for display 124 may also include a back channel through radio 154 and antenna 152. For example, the contact lens may transmit eye tracking data, control data and/or data about the status of the contact lens.

In some embodiments, power is received wirelessly via a power coil (not shown). This is coupled to circuitry that conditions and distributes the incoming power (e.g., converting from AC to DC if needed). The power subsystem may also include energy storage devices, such as batteries 162 or capacitors (not shown), in addition to or instead of the power coil. For example, in some embodiments, the power coil is used to charge the battery 162, which distributes power to the other components in the payload. In some embodiments, the contact lens may comprise the battery 162 but no power coil, or vice versa.

In addition to the payload components shown in FIG. 1C, the overall system may also include components that are outside the contact lens (i.e., off-lens). For example, head tracking and eye tracking functions may be performed partly or entirely off-lens (e.g., sensor within the contact lens may transmit raw sensor data to an external device, which analyzes the received data to calculate a head or eye orientation). The data pipeline may also be performed partially or entirely off-lens.

There are many ways to implement the different system functions. Some portions of the system may be entirely external to the user, while other portions may be worn by the user in the form of a headpiece or glasses. Components may also be worn on a belt, armband, wrist piece, necklace, or other types of packs. For example, in some embodiments, the contact lens may receive image content to be displayed by the femtoprojector 124 from an external device associated with the user via the antenna 152. The external device may further communicate with a server (e.g., a remote server) to generate the image content.

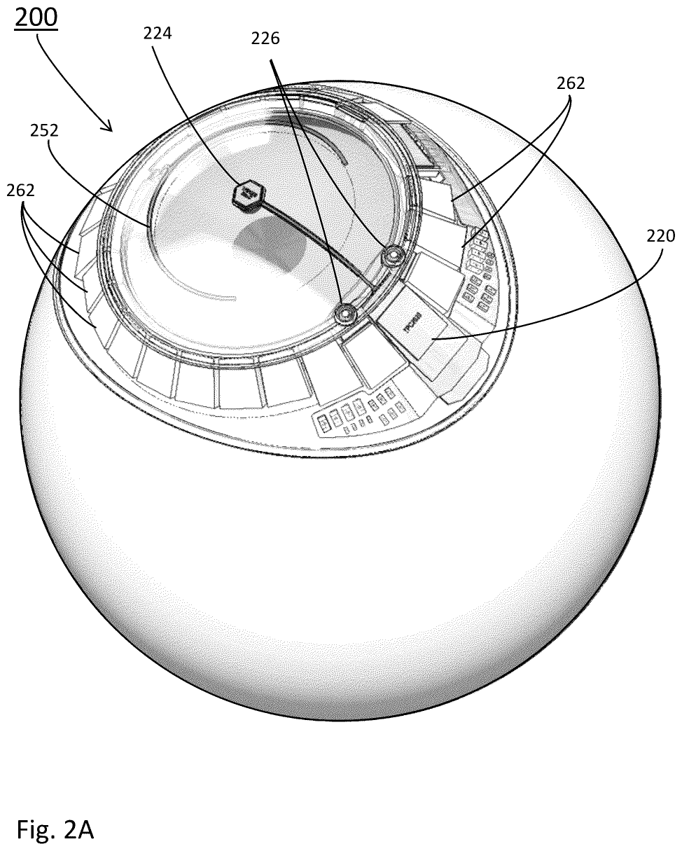

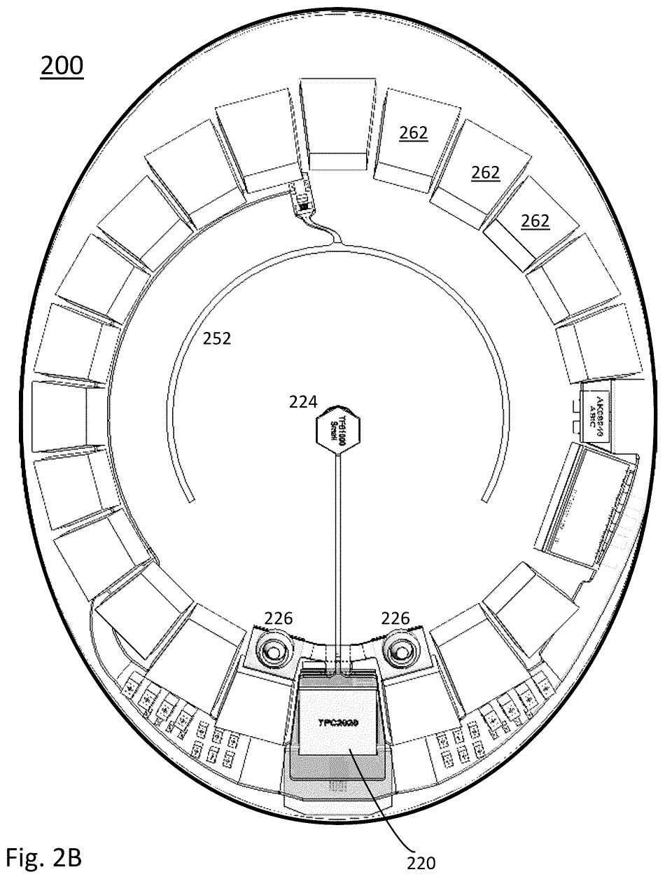

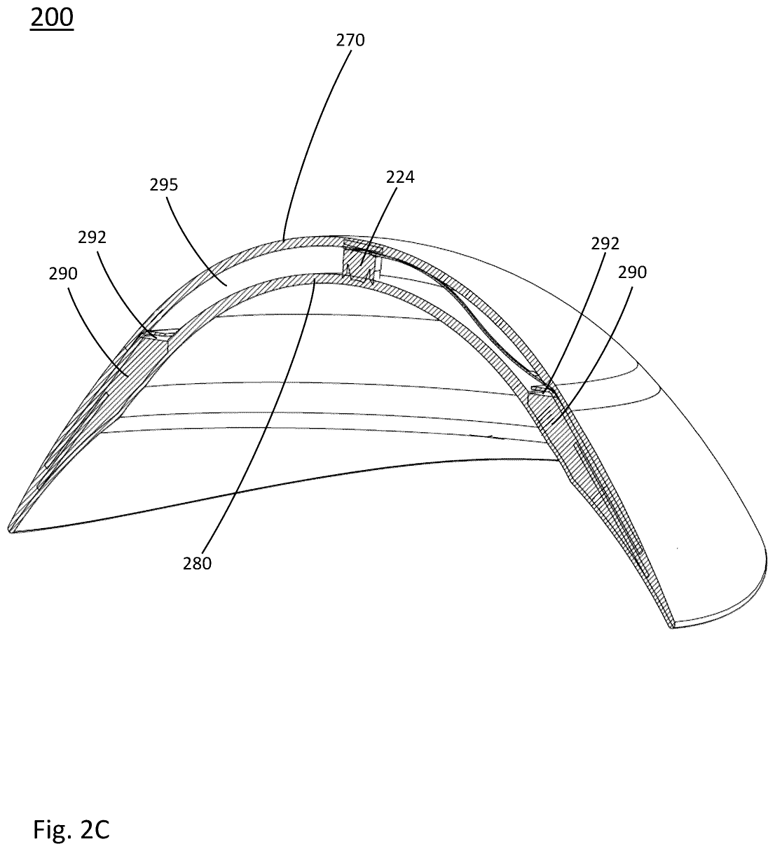

FIG. 2A is a perspective view of an electronic contact lens 200 mounted on a user's eye, in accordance with some embodiments. FIG. 2B is a plan view of the electronic contact lens of FIG. 2A. The electronic contact lens 200 includes a femtoprojector 224 and two outward-facing image sensors 226. Antenna 252 provides wireless communication. Processor 220 provides some on-lens processing capability. Other payload components may include a radio, power management circuitry, internal measurement unit, and magnetometer. The components are powered by batteries 262. These components are mounted on a flexible printed circuit board, with conductive traces providing electrical interconnects between the components.

FIG. 2C is a cross-section through a perspective view of the electronic contact lens 200. In addition to the payload components described above, the electronic contact lens 200 includes a cap 270 and a base 280. The cap 270 is on the anterior surface of the lens and is oxygen-permeable. When the contact lens is worn by the user, the cap 270 is exposed to the external environment and allows oxygen from the external environment to permeate through the cap and into an interior of the contact lens. The base 280 is on the posterior surface and is also oxygen-permeable. When the contact lens is worn by the user, the base 280 is positioned over the user's cornea, thus providing an oxygen path from the interior of the contact lens to the user's cornea.

Structure 290 is formed by a solidification process. In the following examples, the solidification process is a casting process but other processes may be used. Molding and different types of curing (UV curing, thermal curing, etc.) are some examples. The material before solidification may be a liquid, a viscous or gummy material, a gel, or a powder, for example. When solidified, the resulting structure 290 forms an air chamber 295 between the cap 270 and the base 280. If the original material is a liquid, the structure 290 may have a planar surface 292 that corresponds to the top surface of the liquid after solidification. In this example, the solidified structure 290, cap 270 and base 280 form the walls of the chamber. The cap 270, air chamber 295 and base 280 provide an oxygen path from the external environment to the user's cornea. In some cases, the solidified structure 290 also secures the cap 270 and base 280.

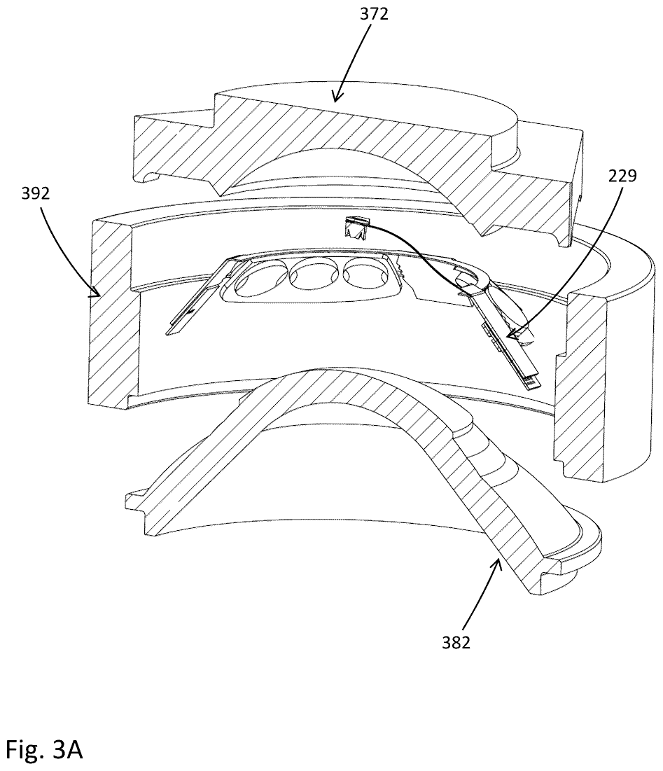

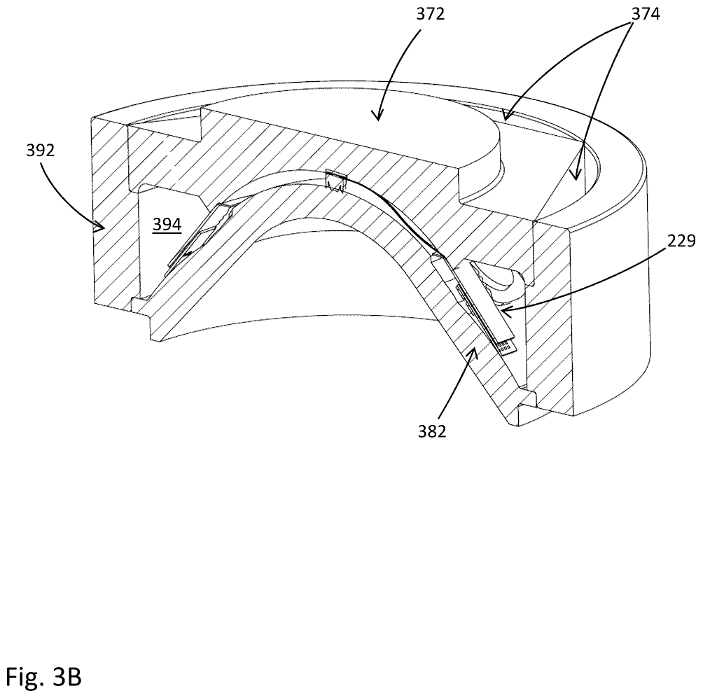

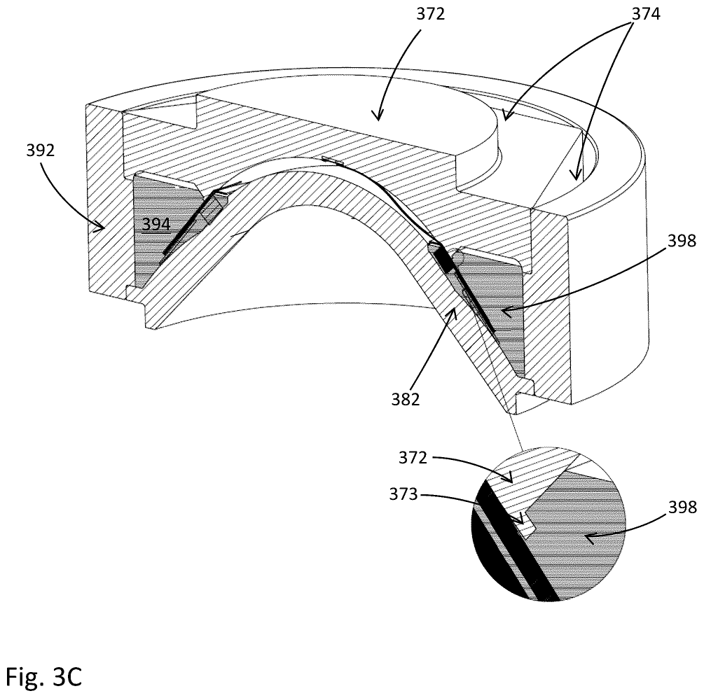

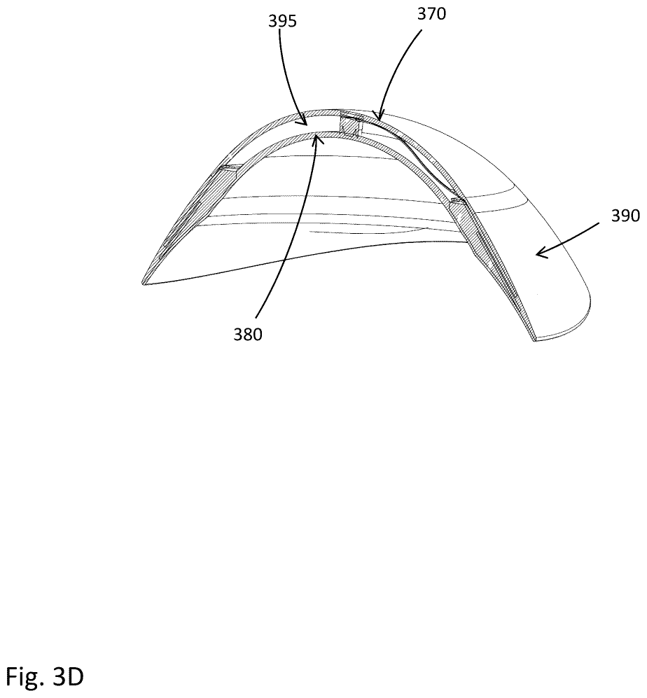

FIGS. 3A-3C are cross-sections illustrating manufacture of an electronic contact lens using a casting process. FIG. 3A shows an exploded view of a precursor 372 to the cap, a precursor 382 to the base, the electronics payload 229, and a side structure 392 that is used during manufacture but is not part of the finished contact lens. The payload 229 contains the printed circuit board and electronics components, for example as described in FIG. 2.

FIG. 3B shows these components after they are assembled. The payload 229 is supported by the base precursor 382. The two precursors 372, 382 and structure 392 fit together to form space 394. In this example, the space 394 is accessible through gaps 374 between the two structures 372, 392. Alternatively, access to space 394 may be provided through holes in the various structures.

In FIG. 3C, material 398 in a liquid form is cast into the space 394. The material hardens into a precursor of the structure 290 in FIG. 2C. The hardened material 398, together with the cap precursor 372 and base precursor 382, forms the air chamber 295 in FIG. 2C. The casting process may seal the joints between the precursors 372, 382 and material 398 without requiring a separate sealing process. It may also encapsulate some of the electronics payload.

In this particular example, the cast material 398 also secures the cap and base. FIG. 3C shows a detail of the interface between cap precursor 372 and cast material 398. The cap precursor 372 is formed with a tab 373, which creates a mechanical interlocking element with cast material 398 once it hardens. A similar approach may be used to secure the base precursor 382, although a mechanical interlock may not be necessary since the surface area between the base precursor 382 and material 398 is much larger compared to the cap precursor 372. Mechanical interlocks may secure the cap and base without the use of glue joints.

The assembly shown in FIG. 3C is then shaped to form the contact lens shown in FIG. 3D. The cap precursor 372 and cast material 398 may be diamond turned to form the anterior surface of the contact lens, including cap 370 of the contact lens. The cast material 398 is shaped to form the final cast structure 390. Similarly, the base precursor 382 may be diamond turned to form the posterior surface of the contact lens, including base 380. In one approach, the shape of cap 370 is standardized, but the shape of the base 380 may be customized for different users. For example, the base 380 may be customized to fit the specific shape of the user's eye or may be customized according to an optical prescription for the user.

Different arrangements of the cap 370, base 380, cast structure 390 and resulting air chamber 395, are possible. In some designs, the cap 370 and base 380 are optically transparent shells of oxygen-permeable material. Both shells may be thin, with maximum thickness of not greater than 500 um or even not greater than 250 um.

The air chamber 395 may have a maximum thickness of not more than 1 mm. It may also have different designs. It does not have to be a single chamber. It may be multiple chambers that may or may not be connected to each other. It may be a network of holes, grooves, vias or other hollow structures that allow oxygen to transport from the cap to the base. It may be just a few such structures that provide oxygen pathways through the core of the payload.

The base 380 has a footprint that is large enough to provide sufficient oxygen to the cornea. For example, the footprint (i.e., projection onto a plane) of the overlap between the base 380 and air chamber 395 may have a minimum diameter of 11 mm or more. The cap 370 has enough surface area to provide sufficient oxygen into the air chamber and through the base. For example, the footprint of the overlap between the cap 370 and the air chamber 395 may have a minimum width of 8 mm or 10 mm or more.

In some cases, the central clear area of the cap 370 and/or base 380 is large enough to avoid seams or interfaces that may degrade the user's vision. For example, both the cap 370 and base 380 may provide a clear aperture over at least a 9 mm diameter central region. If the cap 370 and base 380 are thin with a large central aperture, some mechanical structures may be used to provide mid-span support to either or both. For example, the femtoprojector may be located in a center of the contact lens and provide mechanical support to both the cap 370 and base 380.

In this particular design, the base 380 spans the entire posterior surface of the contact lens, and it is the base 380 that rests on the user's sclera when the contact lens is in place on the user's eye. The cap 370 spans a central region of the anterior surface, and the cast structure 390 is annular in shape including part of the anterior surface outside the cap 370. In alternative designs, the base 380 may not span the entire posterior surface. Instead, the cast structure 390 may form part of the posterior surface and may rest on the user's sclera. As another design variation, the cap 370 and base 380 may or may not make direct contact with each other. For example, each may contact the cast structure 390 but not each other. Alternatively, they may contact each other in addition to contacting the cast structure 390.

As some more examples, the contact lens itself may have different shapes. The footprint of the contact lens does not have to be circular. It may have an elongated footprint, as shown in FIGS. 2A and 2B. It may be elongated along a direction of the user's eye slit. For example, the footprint may be at least 16 mm along the short axis (perpendicular to the eye slit) and at least 20 mm along the long axis (parallel to the eye slit). Extending the contact lens can be used to increase the available volume within the contact lens for payload, especially the volume outside the central aperture of the contact lens. In some designs, the payload may include at least 50 mm³ of payload volume outside an 8 mm diameter central aperture, which payload volume may be used for batteries in addition to other components.

Although the detailed description contains many specifics, these should not be construed as limiting the scope of the invention but merely as illustrating different examples. It should be appreciated that the scope of the disclosure includes other embodiments not discussed in detail above. Various other modifications, changes and variations which will be apparent to those skilled in the art may be made in the arrangement, operation and details of the method and apparatus disclosed herein without departing from the spirit and scope as defined in the appended claims. Therefore, the scope of the invention should be determined by the appended claims and their legal equivalents.

What is claimed is:

1. An electronic contact lens comprising:
an oxygen-permeable base, wherein the base is positioned over a user's cornea when the electronic contact lens is worn by the user;
an oxygen-permeable cap, wherein the cap is exposed to an external environment when the electronic contact lens is worn by the user;
a structure formed by a solidification process comprising inserting material into a space formed by precursors of the base and the cap and solidifying the inserted material in place between the precursors of the base and the cap, wherein the solidified structure forms an air chamber between the base and the cap; and the cap, air chamber and base provide an oxygen path from the external environment to the user's cornea; and
an electronics payload contained in the electronic contact lens.

2. The electronic contact lens of claim 1 wherein the solidified structure includes a mechanical interlocking element formed by the solidification process.

3. The electronic contact lens of claim 2 wherein the mechanical interlocking element secures the base and/or the cap.

4. The electronic contact lens of claim 1 wherein the material inserted into the space is a liquid, and the solidified structure has a planar surface formed by a solidified top surface of the liquid.

5. The electronic contact lens of claim 1 wherein the solidified structure has a central opening of at least 8 mm diameter.

6. The electronic contact lens of claim 1 wherein the base rests on the user's sclera when the electronic contact lens is worn by the user.

7. The electronic contact lens of claim 1 wherein the solidified structure rests on the user's sclera when the electronic contact lens is worn by the user.

8. The electronic contact lens of claim 1 wherein the base comprises a shell of optically transparent, oxygen-permeable material.

9. The electronic contact lens of claim 8 wherein the shell of oxygen-permeable material has a footprint of not less than 11 mm diameter and a maximum thickness of not greater than 500 um.

10. The electronic contact lens of claim 1 wherein the cap comprises a shell of optically transparent, oxygen-permeable material.

11. The electronic contact lens of claim 10 wherein the shell of oxygen-permeable material has a footprint of not less than 8 mm diameter and a maximum thickness of not greater than 500 um.

12. The electronic contact lens of claim 1 wherein:
the base comprises a first shell of optically transparent, oxygen-permeable material having a footprint of not less than 11 mm diameter and a maximum thickness of not greater than 500 um;
the cap comprises a second shell of optically transparent, oxygen-permeable material having a footprint of not less than 8 mm diameter and a maximum thickness of not greater than 500 um; and
the air chamber has a maximum thickness of not more than 1 mm.

13. The electronic contact lens of claim 12 wherein the electronics payload comprises an electronic component located within a 6 mm diameter central region of the contact lens, the electronic component providing mechanical support of the base and the cap.

14. The electronic contact lens of claim 12 wherein the electronic contact lens has an elongated footprint.

15. The electronic contact lens of claim 14 wherein the electronic contact lens contains at least 50 mm³ of payload volume outside a 8 mm diameter central aperture.

16. The electronic contact lens of claim 14 wherein the footprint is at least 16 mm along a short axis and at least 20 mm along a long axis.

17. The electronic contact lens of claim 12 wherein the solidified structure is less rigid than the first and second shells.

18. The electronic contact lens of claim 1 wherein the base is shaped according to an optical prescription for the user.

19. The electronic contact lens of claim 1 wherein the cap is a standard component, and the base is customized for the user.

20. The electronic contact lens of claim 1 wherein the electronics payload comprises a femtoprojector that projects images onto the user's retina.
